(19) United States
(12) Patent Application Publication
(10) Pub. No.: US 2017/0264969 A1
(43) Pub. Date: Sep. 14, 2017

(54) METHOD AND SYSTEM FOR SUPERVISED AND UNSUPERVISED DETECTION OF TELEVISION ADVERTISEMENTS

(71) Applicant: Silveredge Technologies Pvt. Ltd., Gurgaon (IN)

(72) Inventors: Debasish MITRA, Gurgaon (IN); Kishlay KISHORE, Gurgaon (IN); Hitesh CHAWLA, Gurgaon (IN)

(21) Appl. No.: 15/454,284

(22) Filed: Mar. 9, 2017

(30) Foreign Application Priority Data
Mar. 9, 2016 (IN) 201611008283

(51) Int. Cl. H04N 21/81; G06F 17/30; H04N 21/2389; H04N 21/439; H04N 21/44; G06Q 30/02; H04N 21/435

(52) U.S. Cl. CPC H04N 21/812; G06Q 30/0272; G06F 17/3082; H04N 21/435; H04N 21/439; H04N 21/44; H04N 21/23892

(57) ABSTRACT

A system and method for detecting one or more advertisements broadcast on a channel in real time includes a step of extracting a first set of audio fingerprints and a first set of video fingerprints. The first set of audio fingerprints and the first set of video fingerprints correspond to a media content broadcast on the channel. The method also includes a step of generating a set of digital signature values. The set of digital signature values corresponds to an extracted set of video fingerprints. The method also includes a step of detecting the one or more advertisements broadcast on the channel with the processor. The first set of video fingerprints and the audio fingerprints is extracted sequentially in the real time.

### INTRODUCTION

The present invention relates to the field of digital fingerprinting of media content and, in particular, relates to detection of advertisements using digital audio and video fingerprinting.

A television broadcast essentially consists of scheduled programs and sponsored advertisements. Each advertisement is generally scheduled to run for 10 to 35 seconds approximately on multiple channels. The advertisements are provided by advertisers to run in between the scheduled broadcast of the program on each channel. These advertisers derive most of their revenues from these advertisements. Also, these advertisements are important source of revenue and marketing for the channels. As the revenue model of each advertiser is closely associated with airing of their own advertisement or their competitor's advertisements, there is an increase competition between each channel to get the most out of advertisements. This has created a need for detecting airing, frequency and duration of each advertisement broadcasted on their channel and their competitive channels.

Traditionally, these advertisements are detected through a supervised machine learning based approach and an unsupervised machine learning based approach. The unsupervised machine learning based approach focuses on detection of advertisements by extracting and analyzing digital fingerprints of each advertisement. Similarly, the supervised machine learning based approach focuses on mapping and matching digital fingerprints of each advertisement with a known set of digital fingerprints of corresponding advertisement.

In U.S. Pat. No. 9,495,598, an advertisement detection system based on fingerprints is provided. The advertisement detection system includes a content stream storage unit storing broadcast content in real time, a section selection unit selecting a reference section and a test section from broadcast content stored by the storage unit. The advertisement detection system further includes a fingerprint extraction unit extracting fingerprints from the reference section and test section selected by the selection unit and a fingerprint matching unit comparing fingerprints from the test section and reference section. The advertisement detection system extracts the fingerprints and then performing matching between the fingerprints, an advertisement section determination unit determining advertisement segments from the test section based on results of the matching performed by the matching unit, an advertisement DB management unit storing segment information about the advertisement segments determined by the determination unit in an advertisement DB and managing the DB, and a section update unit changing the reference section and test section selected by the selection unit.

In another U.S. Pat. No. 7,164,798, a system and method for learning-based automatic commercial content detection is described. In one aspect, program data is divided into multiple segments. The segments are analyzed to determine visual, audio, and context-based feature sets that differentiate commercial content from non-commercial content. The context-based features are a function of single-side left and/or right neighborhoods of segments of the multiple segments.

In yet another U.S. Pat. No. 7,809,154, a method and system for detection of video segments in compressed digital video streams is presented. The compressed digital video stream is examine to determine synchronization points, and the compressed video signal is analyzed following detection of the synchronization points to create video fingerprints that are subsequently compared against a library of stored fingerprints.

The present systems and methods have several disadvantages. Most of the methods and system rely on supervised detection of repeated advertisements. These methods and system are either not able to detect advertisements or imperfectly determine any new advertisements. In addition, these prior arts lack the precision and accuracy to differentiate programs from advertisements. These prior arts lack any approach and technique for unsupervised detection of any new advertisements.

In light of the above stated discussion, there is a need for a method and system which overcomes the above stated disadvantages.

### SUMMARY

In an aspect, the present disclosure provides a method for detecting one or more advertisements broadcasted on a channel in real time. The method includes a step of extraction of a first set of audio fingerprints and a first set of video fingerprints. The first set of audio fingerprints and the first set of video fingerprints correspond to a media content broadcasted on the channel. The method includes another step of generation of a set of digital signature values. The set of digital signature values corresponds to an extracted set of video fingerprints. The method includes yet another step of detection of the one or more advertisements broadcasted on the channel with the processor. The first set of video fingerprints and the audio fingerprints is extracted sequentially in the real time. The first set of video fingerprints is extracted by sequentially extracting one or more prominent fingerprints corresponding to one or more prominent frames of a pre-defined number of frames present in the media content for a pre-defined interval of broadcast. The generation of each digital signature value of the set of digital signature values is done by dividing each prominent frame of the one or more prominent frames into a pre-defined number of blocks. Further, each block of each prominent frame of the one or more prominent frames is gray scaled. Furthermore, the generation of each digital signature value of the set of digital signature values is done by calculating a first bit value and a second bit value for each block of the prominent frame. In addition, the generation of each digital signature value of the set of digital signature values is done by obtaining a 32 bit digital signature value corresponding to each prominent frame. Each block of the pre-defined number of block has a pre-defined number of pixels. The first bit value and the second bit value is calculated from comparison of a mean and a variance for the pre-defined number of pixels in each block of the prominent frame with a corresponding mean and variance for a master frame. The corresponding mean and variance for the master frame is present in the master database. The 32 bit digital signature value is obtained by sequentially arranging the first bit value and the second bit value for each block of the pre-defined number of blocks of the prominent frame.

In an embodiment of the present disclosure, the method includes yet another step of storage of a generated set of digital signature values, the first set of audio fingerprints and the first set of video fingerprints in a first database and a second database.

In an embodiment of the present disclosure, the first bit value and the second bit value are assigned a binary 0 when the mean and the variance for each block of the prominent frame is less the corresponding mean and variance of each master frame.

In another embodiment of the present disclosure, the first bit value and the second bit value are assigned a binary 1 when the mean and the variance for each block of the prominent frame is greater than the corresponding mean and variance of each master frame.

In an embodiment of the present disclosure, the detection of the one or more advertisements is a supervised detection and an unsupervised detection.

In an embodiment of the present disclosure, the unsupervised detection of the one or more advertisements is done through one or more steps. The one or more steps includes a step of probabilistically matching a first pre-defined number of digital signature values of a real time broadcasted media content with a stored set of digital signature values present in the first database and the second database. The first pre-defined number of digital signature values corresponds to a pre-defined number of prominent frames. Further, the one or more steps include a step of a comparison of one or more prominent frequencies and one or more prominent amplitudes of an extracted first set of audio fingerprints. The one or more steps further include a step of determination of a positive probabilistic match of the pre-defined number of prominent frames based on a pre-defined condition. Furthermore, the one or more steps include a step of fetching of a video and an audio clip corresponding to a probabilistically matched digital signature values. The one or more steps further include a step of checking for presence of the audio and the video clip manually in the master database. In addition, the one or more steps includes a step of reporting a positively matched digital signature values corresponding to an advertisement of the one or more advertisement in a reporting database present in the first database. The probabilistic match is performed for the set of digital signature values by utilizing a sliding window algorithm.

In an embodiment of the present disclosure, the pre-defined condition includes a pre-defined range of positive matches corresponding to probabilistically matched digital signature values, a pre-defined duration of media content corresponding to the positive match. In addition, the predefined condition includes a sequence and an order of the positive matches and a degree of positive match of a pre-defined range of number of bits of the first pre-defined number of signature values.

In an embodiment of the present disclosure, the first pre-defined number of digital signature values of the set of digital signature values for the unsupervised detection of the one or more advertisements is 20.

In an embodiment of the present disclosure, the method includes yet another step of update of a first metadata comprising the set of digital signature values and the first set of video fingerprints with the processor. The set of digital signature values and the first set of video fingerprints correspond to a detected advertisement and updated manually in the master database for the unsupervised detection.

In an embodiment of the present disclosure, the supervised detection of the one or more advertisements is done through one or more steps. The one or more steps includes a step of probabilistically matching a second pre-defined number of digital signature values corresponding to a pre-defined number of prominent frames of a real time broadcasted media content with a stored set of digital signature values. The stored set of digital signature values is present in the master database. Further, the one or more steps includes a step of comparing the one or more prominent frequencies and the one or more prominent amplitudes corresponding to the extracted first set of audio fingerprints with a stored one or more prominent frequencies and a stored one or more prominent amplitudes. Furthermore, the one or more steps include a determination of the positive match in the probabilistically matching of the second pre-defined number of digital signature values with the stored set of digital signature values in the master database. In addition, the one or more steps includes a step of comparing the one or more prominent frequencies and the one or more prominent amplitudes corresponding to the extracted first set of audio fingerprints with the stored one or more prominent frequencies and the stored one or more prominent amplitudes. The probabilistic match being performed for the set of digital signature values by utilizing a sliding window algorithm.

In an embodiment of the present disclosure, the second pre-defined number of digital signature values of the set of digital signature values for the supervised detection of the one or more advertisements is 6.

In another aspect, the present disclosure provides a computer system. The computer system includes one or more processors and a memory. The memory is coupled to the one or more processors. The memory is used to store instructions. The instructions in the memory when executed by the one or more processors cause the one or more processors to perform a method. The one or more processors perform the method for detecting one or more advertisements broadcasted on a channel in real time. The method includes a step of extraction of a first set of audio fingerprints and a first set of video fingerprints. The first set of audio fingerprints and the first set of video fingerprints correspond to a media content broadcasted on the channel. The method includes another step of generation of a set of digital signature values. The set of digital signature values corresponds to an extracted set of video fingerprints. The method includes yet another step of detection of the one or more advertisements broadcasted on the channel with the processor. The first set of video fingerprints and the audio fingerprints is extracted sequentially in the real time. The first set of video fingerprints is extracted by sequentially extracting one or more prominent fingerprints corresponding to one or more prominent frames of a pre-defined number of frames present in the media content for a pre-defined interval of broadcast. The generation of each digital signature value of the set of digital signature values is done by dividing each prominent frame of the one or more prominent frames into a pre-defined number of blocks. Further, each block of each prominent frame of the one or more prominent frames is gray scaled. Furthermore, the generation of each digital signature value of the set of digital signature values is done by calculating a first bit value and a second bit value for each block of the prominent frame. In addition, the generation of each digital signature value of the set of digital signature values is done by obtaining a 32 bit digital signature value corresponding to each prominent frame. Each block of the pre-defined number of block has a pre-defined number of pixels. The first bit value and the second bit value is calculated from comparison of a mean and a variance for the pre-defined number of pixels in each block of the prominent frame with a corresponding mean and variance for a master frame. The corresponding mean and variance for the master frame is present in the master database. The 32 bit digital signature value is obtained by sequentially arranging the first bit value and the second bit value for each block of the pre-defined number of blocks of the prominent frame.

In yet another aspect, the present disclosure provides a computer-readable storage medium. The computer readable storage medium enables encoding of computer executable instructions. The computer executable instructions when executed by at least one processor perform a method. The at least one processor performs the method for detecting one or more advertisements broadcasted on a channel in real time. The method includes a step of extraction of a first set of audio fingerprints and a first set of video fingerprints. The first set of audio fingerprints and the first set of video fingerprints correspond to a media content broadcasted on the channel. The method includes another step of generation of a set of digital signature values. The set of digital signature values corresponds to an extracted set of video fingerprints. The method includes yet another step of detection of the one or more advertisements broadcasted on the channel with the processor. The first set of video fingerprints and the audio fingerprints is extracted sequentially in the real time. The first set of video fingerprints is extracted by sequentially extracting one or more prominent fingerprints corresponding to one or more prominent frames of a pre-defined number of frames present in the media content for a pre-defined interval of broadcast. The generation of each digital signature value of the set of digital signature values is done by dividing each prominent frame of the one or more prominent frames into a pre-defined number of blocks. Further, each block of each prominent frame of the one or more prominent frames is gray scaled. Furthermore, the generation of each digital signature value of the set of digital signature values is done by calculating a first bit value and a second bit value for each block of the prominent frame. In addition, the generation of each digital signature value of the set of digital signature values is done by obtaining a 32 bit digital signature value corresponding to each prominent frame. Each block of the pre-defined number of block has a pre-defined number of pixels. The first bit value and the second bit value is calculated from comparison of a mean and a variance for the pre-defined number of pixels in each block of the prominent frame with a corresponding mean and variance for a master frame. The corresponding mean and variance for the master frame is present in the master database. The 32 bit digital signature value is obtained by sequentially arranging the first bit value and the second bit value for each block of the pre-defined number of blocks of the prominent frame.

### BRIEF DESCRIPTION OF THE DRAWINGS

Having thus described the invention in general terms, reference will now be made to the accompanying drawings, which are not necessarily drawn to scale, and wherein:

FIG. 1A illustrates a system for a supervised and a unsupervised detection of one or more advertisements broadcasted on a channel, in accordance with an embodiment of the present disclosure;

FIG. 1B illustrates a system for the unsupervised detection of the one or more advertisements broadcasted on the channel, in accordance with another embodiment of the present disclosure;

FIG. 1C illustrates a system for the supervised detection of the one or more advertisements broadcasted on the channel, in accordance with yet another embodiment of the present disclosure;

FIG. 2 illustrates a block diagram of an advertisement detection system, in accordance with various embodiments of the present disclosure;

FIG. 3 illustrates a flow chart for the unsupervised detection of the one or more advertisements broadcasted on the channel, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

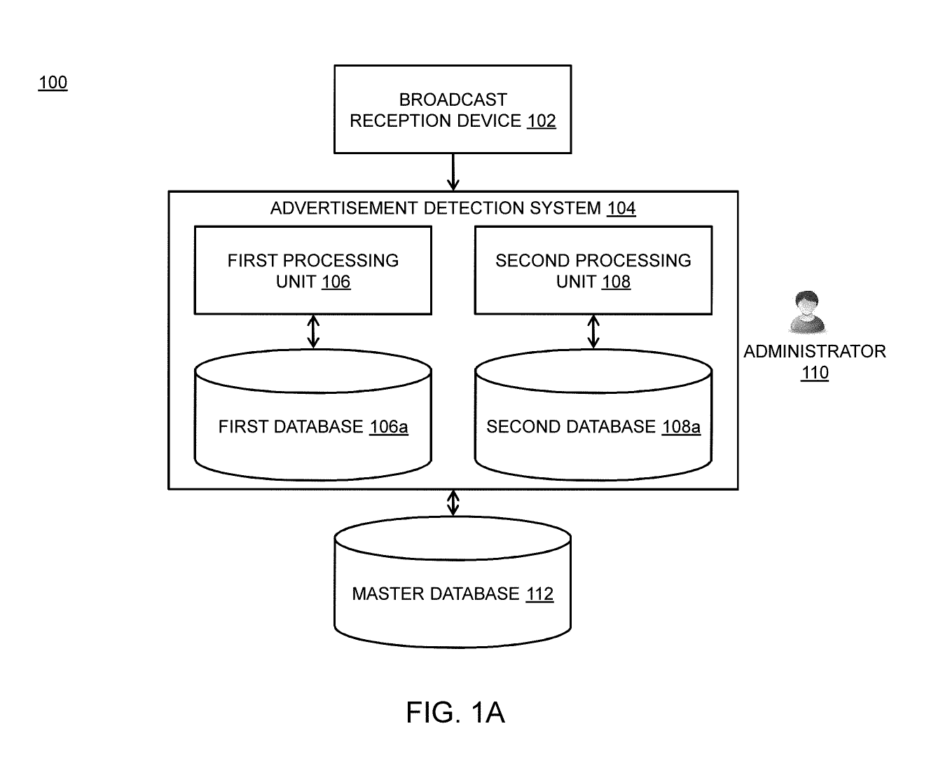

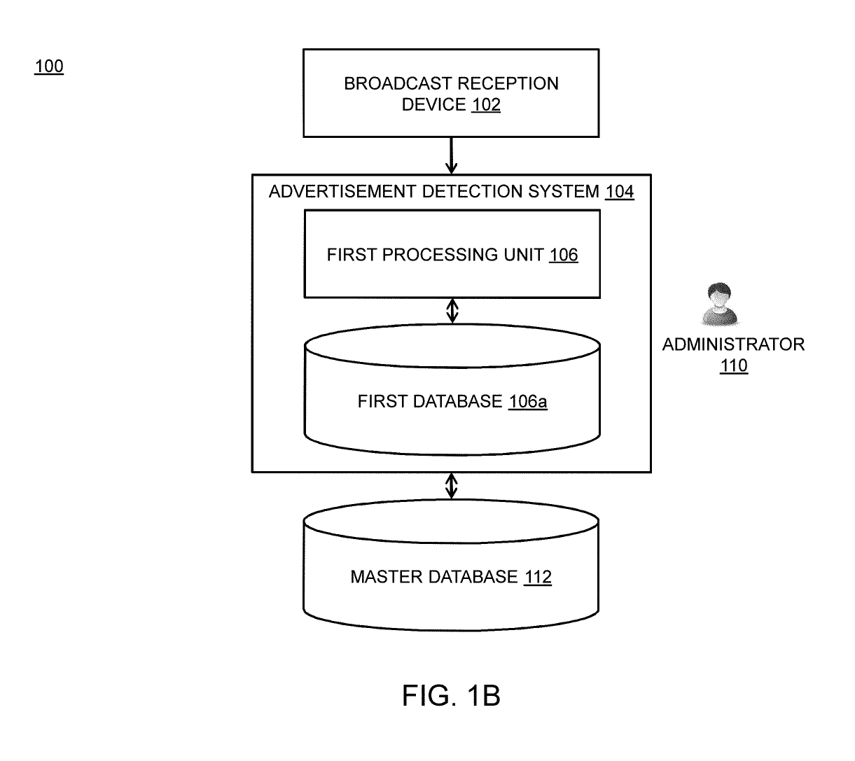

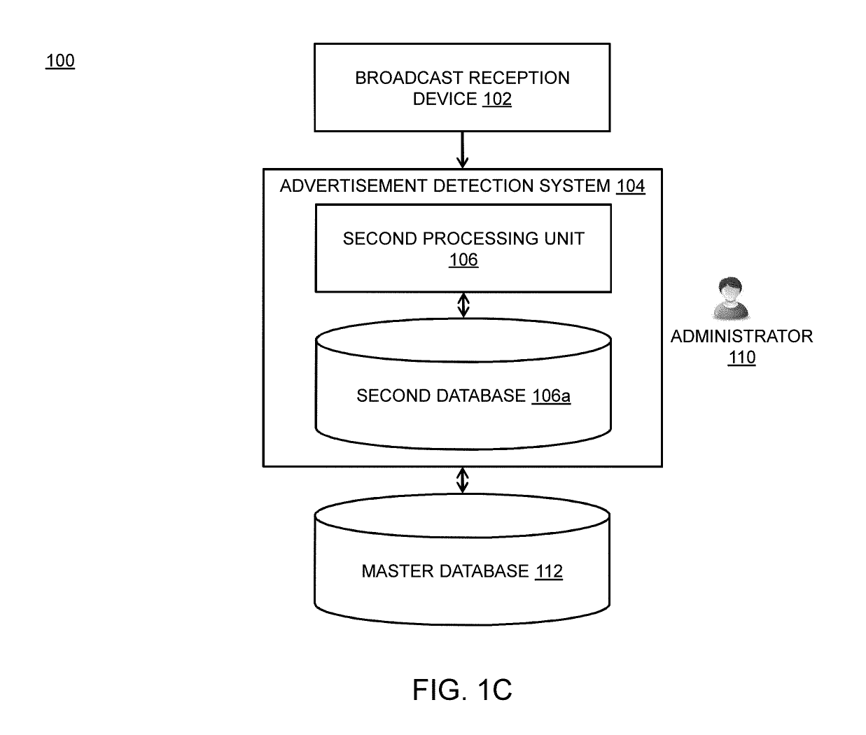

FIG. 1A illustrates a system 100 for a supervised and an unsupervised detection of one or more advertisements broadcasted on a channel, in accordance with an embodiment of the present disclosure. The system 100 describes an environment suitable for an interactive reception and processing of a channel broadcast. The system 100 is configured to provide a setup for detection of the one or more advertisements.

The system 100 includes a broadcast reception device 102, an advertisement detection system 104 and a master database 112. The above stated elements of the system 100 operate coherently and synchronously to detect the one or more advertisements present in media content broadcasted in the channel. The broadcast reception device 102 is a channel feed receiving and processing device. The broadcast reception device 102 is attached directly or indirectly to a receiving antenna or dish.

The receiving antenna receives a broadcasted signal carrying one or more channel feeds. The one or more channel feeds are encoded in a pre-defined format. In addition, the one or more channel feeds have a set of characteristics. The set of characteristics includes a frame rate, an audio sample rate, one or more frequencies and the like.

The broadcasted signal carrying the one or more channel feeds is initially transmitted from a transmission device. In an embodiment of the present disclosure, the broadcasted signal carrying the one or more channel feeds is a multiplexed MPEG-2 encoded signal having a constant bit rate. In another embodiment of the present disclosure, the broadcasted signal carrying the one or more channel feeds is a multiplexed MPEG-2 encoded signal having a variable bit rate. In yet another embodiment of the present disclosure, the broadcasted signal carrying the one or more channel feeds is any digital standard encoded signal. The bit rate is based on complexity of each frame in each of the one or more channel feeds. The quality of the multiplexed MPEG-2 encoded signal will be reduced when the broadcasted signal is too complex to be coded at a constant bit-rate. The bit rate of the variable bit-rate MPEG-2 streams is adjusted dynamically as less bandwidth is needed to encode the images with a given picture quality. In addition, the broadcasted signal is encrypted for a conditional access to a particular subscriber. The encrypted broadcast signal is uniquely decoded by the broadcast reception device 102 uniquely.

In an example, a digital TV signal is received on the broadcast reception device 102 as a stream of MPEG-2 data. The MPEG-2 data has a transport stream. The transport stream has a data rate of 40 megabits/second for a cable or satellite network. Each transport stream consists of a set of sub-streams. The set of sub-streams is defined as elementary streams. Each elementary stream includes an MPEG-2 encoded audio, an MPEG-2 encoded video and data encapsulated in an MPEG-2 stream. In addition, each elementary stream includes a packet identifier (hereinafter “PID”) that acts as a unique identifier for corresponding elementary stream within the transport stream. The elementary streams are split into packets in order to obtain a packetized elementary stream (hereinafter “PES”).

In an embodiment of the present disclosure, the broadcast reception device 102 is a digital set top box. In another embodiment of the present disclosure, the broadcast reception device 102 is a hybrid set top box. In yet another embodiment of the present disclosure, the broadcast reception device 102 is any standard broadcast signal processing device. Further, the broadcast reception device 102 may receive the broadcast signal from any broadcast signal medium. In an embodiment of the present disclosure, the broadcast signal medium is an ethernet cable. In another embodiment of the present disclosure, the broadcast signal medium is a satellite dish. In yet another embodiment of the present disclosure, the broadcast signal medium is a coaxial cable. In yet another embodiment of the present disclosure, the broadcast signal medium is a telephone line having DSL connection. In yet another embodiment of the present disclosure, the broadcast signal medium is a broadband over power line (hereinafter “BPL”). In yet another embodiment of the present disclosure, the broadcast signal medium is an ordinary VHF or UHF antenna.

The broadcast reception device 102 primarily includes a signal input port, an audio output port, a video output port, a de-multiplexer, a video decoder, an audio decoder and a graphics engine. The broadcast signal carrying the one or more channel feeds is received at the signal input port. The broadcast signal carrying the one or more channel feeds is de-multiplexed by the de-multiplexer. The video decoder decodes the encoded video and the audio decoder decodes the encoded audio. The video and audio corresponds to a channel selected in the broadcast reception device 102. In general, the broadcast reception device 102 carries the one or more channel feeds multiplexed to form a single transporting stream. The broadcast reception device 102 can decode only one channel in real time.

Further, the decoded audio and the decoded video are received at the audio output port and the video output port. Further, the decoded video has a first set of features. The first set of features includes a frame height, a frame width, a frame rate, a video resolution, a bit rate and the like. Moreover, the decoded audio has a second set of features. The second set of features includes a sample rate, a bit rate, a bin size, one or more data points, one or more prominent frequencies and one or more prominent amplitudes. Further, the decoded video may be of any standard quality. In an embodiment of the present disclosure, the decoded video signal is a 144p signal. In another embodiment of the present disclosure, the decoded video signal is a 240p signal. In yet another embodiment of the present disclosure, the decoded video signal is a 360p signal. In yet another embodiment of the present disclosure, the decoded video signal is a 480p signal. In yet another embodiment of the present disclosure, the decoded video signal is a 720p video signal. In yet another embodiment of the present disclosure, the decoded video signal is a 1080p video signal. In yet another embodiment of the present disclosure, the decoded video signal is a 1080i video signal. Here, p and i denotes progressive scan and interlace scan techniques.

Further, the decoded video and the decoded audio (hereinafter “media content”) are transferred to the advertisement detection system 104 through a transfer medium. The transfer medium can be a wireless medium or a wired medium. Moreover, the media content includes one or more television programs, the one or more advertisements, one or more channel related data, subscription related data, operator messages and the like. The media content has a pre-defined frame rate, a pre-defined number of frames and a pre-defined bit rate for a pre-defined interval of broadcast. The advertisement detection system 104 includes a first processing unit 106 and a second processing unit 108. The advertisement detection system 104 has a built in media splitter configured to copy and transmit the media content synchronously to the first processing unit 106 and the second processing unit 108 in the real time. The first processing unit 106 includes a first central processing unit and associated peripherals for unsupervised detection of the one or more advertisements (also shown in FIG. 1B). The first processing unit 106 is connected to a first database 106a.

In an embodiment of the present disclosure, the first processing unit 106 performs histogram normalization of each frame of the media content broadcasted on the channel. The first processing unit 106 performs the histogram normalization. The first processing unit 106 sets each pixel value in each frame of the media content to a standard pixel value range set as a standard for each detected advertisement. In another embodiment of the present disclosure, the first processing unit 106 skips the histogram normalization.

In an embodiment of the present disclosure, the first processing unit 106 scales each frame of the media content to a pre-defined scale. In an embodiment of the present disclosure, the pre-defined scale of each frame is 640 by 480. In an embodiment of the present disclosure, the scaling of each frame is done by trimming a first region corresponding to a channel logo and a second region corresponding to a channel's dynamic ticker. In another embodiment of the present disclosure, the scaling of each frame is done by trimming the first region corresponding to the channel's dynamic ticker and the second region corresponding to the channel logo. In another embodiment of the present disclosure, the first processing unit 106 skips the scaling of each frame when each frame has the pre-defined scale.

The first processing unit 106 performs extraction of a first set of audio fingerprints and a first set of video fingerprints corresponding to the media content broadcasted on the channel. The first set of video fingerprints and the first set of audio fingerprints are extracted sequentially in the real time. The extraction of the first set of video fingerprints is done by sequentially extracting one or more prominent fingerprints corresponding to one or more prominent frames present in the media content. The one or more prominent frames correspond to the pre-defined interval of broadcast.

For example, let the media content be related to a channel say, X. The channel X broadcasts a 1 hour drama show between 10 AM to 11 AM. Suppose the media content is broadcasted on the channel X with a frame rate of 25 frames per second (hereinafter “fps”). Again let us assume that the channel X administrator has placed 5 advertisements in between 1 hour broadcast of the drama show. The first processing unit 106 separates audio and video from the media content corresponding to the drama show in the real time. Further, the first processing unit 106 sets a pre-defined range of time to approximate duration of play of every advertisement. Let us suppose the pre-defined range of time is between 10 seconds to 35 seconds. The first processing unit 106 processes each frame of the pre-defined number of frames of the 1 hour long drama show. The first processing unit 106 filters and selects prominent frames having dissimilar scenes. The first processing unit 106 extracts relevant characteristics corresponding to each prominent frame. The relevant characteristics constitute a digital video fingerprint. Similarly, the first processing unit 106 extracts the first set of audio fingerprints corresponding to the media content.

Furthermore, each of the one or more prominent fingerprints corresponds to a prominent frame having sufficient contrasting features compared to an adjacent prominent frame. For example, let us suppose that the first processing unit 106 select 5 prominent frames per second from 25 frames per second. Each pair of adjacent frames of the 5 prominent frames will have evident contrasting features. The first processing unit 106 generates a set of digital signature values corresponding to an extracted set of video fingerprints. The first processing unit 106 generates each digital signature value of the set of digital signature values by dividing each prominent frame of the one or more prominent frames into a pre-defined number of blocks. In an embodiment of the present disclosure, the predefined number of block is 15 (4×4). In another embodiment of the present disclosure, the pre-defined number of blocks is any suitable number. Each block of the pre-defined number of blocks has a pre-defined number of pixels. Each pixel is fundamentally a combination of red (hereinafter “R”), green (hereinafter “G”) and blue (hereinafter “B”) colors. The colors are collectively referred to as RGB. Each color of a pixel (RGB) has a pre-defined value in a pre-defined range of values. The predefined range of values is 0-255.

In an example, the RGB for the pixel has value of 000000. The color of pixel is black. In another example, the RGB for the pixel has a value of FFFFFF (255; 255; 255). The color of the pixel is white. Here, FF is hexadecimal equivalent of decimal, 255. In yet another example, the RGB for the pixel has a value of CCCC00 (204; 204; 0). The color of the pixel is yellow. The first processing unit 106 gray-scales each block of each prominent frame of the one or more prominent frames. The gray-scaling of each block is a conversion of RGB to monochromatic shades of grey color. Here 0 represents black and 255 represents white. Further, the first processing unit 106 calculates a first bit value and a second bit value for each block of the prominent frame. The first bit value and the second bit value are calculated from comparing a mean and a variance for the pre-defined number of pixels in each block of the prominent frame with a corresponding mean and variance for a master frame in the master database 112. The first processing unit 106 assigns the first bit value and the second bit with a binary 0 when the mean and the variance for each block of the prominent frame is less the corresponding mean and variance of each master frame. The first processing unit 106 assigns the first bit value and the second bit value with a binary 1 when the mean and the variance for each block is greater than the corresponding mean and variance of each master frame.

Furthermore, the first processing unit 106 obtains a 32 bit digital signature value corresponding to each prominent frame. The 32 bit digital signature value is obtained by sequentially arranging the first bit value and the second bit value for each block of the pre-defined number of blocks of the prominent frame. The first processing unit 106 stores each digital signature value corresponding to each prominent frame of the one or more prominent frames in the first database 106a. The digital signature value corresponds to the one or more programs and the one or more advertisements. The first processing unit 106 utilizes a sliding window algorithm to detect the one or more advertisements. In sliding window algorithm, the first processing unit 106 probabilistically matches a first pre-defined number of digital signature values with a stored set of digital signature values present in the first database 106a.

In an example, let us suppose that the first processing unit 106 generates 100 digital signature values corresponding to 100 prominent frames in the first database 106a. The first processing unit 106 probabilistically matches 20 digital signature values corresponding to 101^{st} to 121^{st} prominent frame with each 20 digital signature values corresponding to 100 previously stored prominent frames.

The probabilistic match of the first pre-defined number of digital signature values sequentially for each of the prominent frame is performed by utilizing a sliding window algorithm. In an embodiment of the present disclosure, the first pre-defined number of digital signature values of the set of digital signature values for the unsupervised detection of the one or more advertisements is 20. The first processing unit 106 determines a positive probabilistic match of the pre-defined number of prominent frames based on a pre-defined condition. The pre-defined condition includes a pre-defined range of positive matches corresponding to probabilistically match digital signature values and a pre-defined duration of media content corresponding to the positive match. In addition, the pre-defined condition includes a sequence and an order of the positive matches and a degree of match of a pre-defined range of number of bits of the first pre-defined number of signature values. In an embodiment of the present disclosure, the pre-defined range of probabilistic matches corresponding to the positive match lies in a range of 40 matches to 300 matches. In another embodiment of the present disclosure, the pre-defined range of range of probabilistic matches corresponding to the positive match lies in a suitable duration of each advertisement running time. In an embodiment of the present disclosure, the first processing unit 106 discards the probabilistic matches corresponding to less than 40 positive matches.

Further, the pre-defined duration of media content corresponding to the positive match has a first limiting duration bounded by a second limiting duration. In an embodiment of the present disclosure, the first limiting duration is 10 seconds and the second limiting duration is 25 seconds. In another embodiment of the present disclosure, the first limiting duration is 10 seconds and the second limiting duration is 35 seconds. In yet another embodiment of the present disclosure, the first limiting duration is 10 seconds and the second limiting duration is 60 seconds. In yet another embodiment of the present disclosure, the first limiting duration is 10 seconds and the second limiting duration is 90 seconds. In yet another embodiment of the present disclosure, the first limiting duration and the second limiting duration may have any suitable limiting durations.

In an example, suppose 100 digital signature values from 1000th prominent frame to 1100th prominent frame gives a positive match with a stored 100th frame to 200th frame in the first database 106a. The first processing unit 106 checks whether the number of positive matches in the pre-defined range of positive matches and the positive matches correspond to media content in the first limiting duration and the second limiting duration. In addition, the first processing unit 106 checks whether the positive matches of 100 digital signature values for unsupervised detection of the one or more advertisements is in a required sequence and order.

The first processing unit 106 checks for the degree of match of the pre-defined range of number of bits of the first pre-defined number of signature values. In an example, the degree of match of 640 bits (32 Bits×20 digital signature values) of the generated set of digital signature values with stored 640 digital signature values is 620 bits. In such case, the first processing unit 106 flags the probabilistic match as the positive match. In another example, the degree of match of 640 bits of the generated set of digital signature values with stored 640 digital signature values is 550 bits. In such case, the first processing unit 106 flags the probabilistic match as the negative match. In an embodiment of the present disclosure, the pre-defined range of number of bits is 0-40.

The first processing unit 106 generates one or more prominent frequencies and one or more prominent amplitudes from extracted first set of audio fingerprints. The first processing unit 106 fetches a sample rate of first set of audio fingerprints. The sample rate is divided by a pre-defined bin size set for the audio. The division of the sample rate by the pre-defined bin size provides the data point. Further, the first processing unit 106 performs fast fourier transform (hereinafter “FFT”) on each bin size of the audio to obtain the one or more prominent frequencies and the one or more prominent amplitudes. The first processing unit 106 compares the one or more prominent frequencies and the one or more prominent amplitudes with a stored one or more prominent frequencies and a stored one or more prominent amplitudes.

In an embodiment of the present disclosure, the media content broadcasted on another channel uses a pre-defined regional language in the audio. In another embodiment of the present disclosure, the media content broadcasted on another channel uses a standard language accepted nationally.

In an embodiment of the present disclosure, the broadcast reception device 102 receives media content corresponding to the broadcasted content having audio in the pre-defined regional language or the standard language. The media content corresponds to another channel.

In an embodiment of the present disclosure, the first processing unit 106 extracts the first set of audio fingerprints and the first set of video fingerprints corresponding to another channel. The first processing unit 106 extracts the pre-defined number of prominent frames and generates pre-defined number of digital signature values. The first processing unit 106 performs the sliding window algorithm to detect a new advertisement. In an embodiment of the present disclosure, the first processing unit 106 generates prominent frequencies and prominent amplitudes of the audio. In another embodiment of the present disclosure, the first processing unit 106 discards the audio from the media content. In an embodiment of the present disclosure, the first processing unit 106 probabilistically matches the one or more prominent frequencies with stored prominent frequencies in the first database 106a. The stored prominent frequencies and the stored prominent amplitudes correspond to a regional channel having audio in the pre-defined regional language or standard language. In an embodiment of the present disclosure, the standard language is English. In another embodiment of the present disclosure, the first processing unit 106 gives precedence to results of probabilistic match of video fingerprints than to the audio fingerprints. In an embodiment of the present disclosure, the administrator 110 manually tags the detected advertisement broadcasted in the pre-defined regional language or the standard language. In another embodiment of the present disclosure, the advertisement detection system 104 automatically tags the detected advertisement broadcasted in the pre-defined regional language or the standard language.

Going further, the first processing unit 106 fetches the corresponding video and audio clip associated to the probabilistically matched digital signature values. The first database 106a and the first processing unit 106 are associated with an administrator 110. The administrator 110 is associated with a display device and a control and input interface. In addition, the display device is configured to display a graphical user interface (hereinafter “GUI”) of an installed operating system. The administrator 110 checks for the presence of the audio and the video clip manually in the master database 112. The administrator 110 decides whether the audio clip and the video clip correspond to a new advertisement. The administrator 110 tags each audio clip and the video clip with a tag. The tag corresponds to a brand name associated with a detected advertisement. The administrator 110 stores the metadata of the probabilistically matched digital fingerprint values in the master database 112.

In addition, the first processing unit 106 reports a positively matched digital signature values corresponding to each detected advertisement in a reporting database present in the first database 106a. The first processing unit 106 discards any detected advertisement already reported in the reporting database.

In an embodiment of the present disclosure, the second processing unit 108 performs the histogram normalization of each frame of the media content broadcasted on the channel. The second processing unit 108 performs the histogram normalization. The second processing unit 108 sets each pixel value in each frame of the media content to a standard pixel value range set as a standard for each detected advertisement. In another embodiment of the present disclosure, the second processing unit 108 skips the histogram normalization.

In an embodiment of the present disclosure, the second processing unit 108 scales each frame of the media content to a pre-defined scale. In an embodiment of the present disclosure, the pre-defined scale of each frame is 640 by 480. In an embodiment of the present disclosure, the scaling of each frame is done by trimming a first region corresponding to a channel logo and a second region corresponding to a channel's dynamic ticker. In another embodiment of the present disclosure, the scaling of each frame is done by trimming the first region corresponding to the channel's dynamic ticker and the second region corresponding to the channel logo. In another embodiment of the present disclosure, the second processing unit 108 skips the scaling of each frame when each frame has the pre-defined scale.

The second processing unit 108 includes a second central processing unit and associated peripherals for supervised detection of the one or more advertisements (also shown in FIG. 1C). The second processing unit 106 is connected to a second database 108a. The second processing unit 108 is programmed to perform the extraction of the first set of audio fingerprints and the first set of video fingerprints corresponding to the media content broadcasted on the channel. The first set of video fingerprints and the first set of audio fingerprints are extracted sequentially in the real time. The extraction of the first set of video fingerprints is done by sequentially extracting the one or more prominent fingerprints corresponding to the one or more prominent frames for the pre-defined interval of broadcast.

Furthermore, each of the one or more prominent fingerprints corresponds to the prominent frame having sufficient contrasting features compared to the adjacent prominent frame. For example, let us suppose that the second processing unit 108 selects 6 prominent frames per second from 25 frames per second. Each pair of adjacent frames of the 6 prominent frames will have evident contrasting features. The second processing unit 108 generates the set of digital signature values corresponding to the extracted set of video fingerprints. The second processing unit 108 generates each digital signature value of the set of digital signature values by dividing each prominent frame of the one or more prominent frames into the pre-defined number of blocks. In an embodiment of the present disclosure, the predefined number of block is 15 (4×4). In another embodiment of the present disclosure, the pre-defined number of blocks is any suitable number. Each block of the pre-defined number of blocks has the pre-defined number of pixels. Each pixel is fundamentally the combination of R, G and B colors. The colors are collectively referred to as RGB. Each color of the pixel (RGB) has the pre-defined value in the pre-defined range of values. The predefined range of values is 0-255.

The second processing unit 108 gray-scales each block of each prominent frame of the one or more prominent frames. The second processing unit 108 calculates the first bit value and the second bit value for each block of the prominent frame. The first bit value and the second bit value are calculated from comparison of the mean and the variance for the pre-defined number of pixels with the corresponding mean and variance for the master frame. The master frame is present in the master database 112. The second processing unit 108 assigns the first bit value and the second bit with the binary 0 when the mean and the variance for each block is less the corresponding mean and variance of each master frame. The second processing unit 108 assigns the first bit value and the second bit value with the binary 1 when the mean and the variance for each block is greater than the corresponding mean and variance of each master frame.

The second processing unit 108 obtains the 32 bit digital signature value corresponding to each prominent frame. The 32 bit digital signature value is obtained by sequentially arranging the first bit value and the second bit value for each block of the pre-defined number of blocks of the prominent frame. The second processing unit 108 stores each digital signature value corresponding to each prominent frame of the one or more prominent frames in the second database 108a. The digital signature value corresponds to the one or more programs and the one or more advertisements.

The second processing unit 108 performs the supervised detection of the one or more advertisements. The second processing unit 108 probabilistically matches a second pre-defined number of digital signature values with the stored set of digital signature values present in the master database 112. The second pre-defined number of digital signature values corresponds to the second pre-defined number of prominent frames of the real time broadcasted media content. The probabilistic match is performed for the set of digital signature values by utilizing a sliding window algorithm. The second processing unit 108 determines the positive match in the probabilistically matching of the second pre-defined number of digital signature values with the stored set of digital signature values. The stored set of digital signal values is present in the master database 112. In an embodiment of the present disclosure, the second pre-defined number of digital signature values of the set of digital signature values for the supervised detection of the one or more advertisements is 6. In another embodiment of the present disclosure, the second pre-defined number of digital signature values is selected based on optimal processing capacity and performance of the second processing unit 108.

In an example, let us suppose that the second processing unit 108 stores 300 digital signature values corresponding to 300 prominent frames in the second database 108a for 10 seconds of the media content. The second processing unit 108 probabilistically matches 6 digital signature values corresponding to 101^{st} to 107^{st} prominent frame with each 6 digital signature values corresponding to 300 previously stored prominent frames. The 300 previously stored prominent frames are present in the master database 112.

In another example, suppose 300 digital signature values from 500th prominent frame to 800th prominent frame gives a positive match with a stored 150th frame to 450th frame in the master database 112. The second processing unit 108 checks whether the number of positive matches is in the pre-defined range of positive matches and the positive matches correspond to media content in the first limiting duration and the second limiting duration. In addition, the second processing unit 108 checks whether the positive matches of 300 digital signature values for supervised detection of the one or more advertisements is in the required sequence and order.

The second processing unit 108 checks for the degree of match of the pre-defined range of number of bits of the second pre-defined number of signature values. In an example, the degree of match of 192 bits of the generated set of digital signature values with stored 192 digital signature values is 185 bits. In such case, the second processing unit 108 flags the probabilistic match as the positive match. In another example, the degree of match of 192 bits of the generated set of digital signature values with stored 192 digital signature values is 179 bits. In such case, the second processing unit 108 flags the probabilistic match as the negative match. In an embodiment of the present disclosure, the pre-defined range of number of bits is 0-12.

The second processing unit 108 compares the one or more prominent frequencies and the one or more prominent amplitudes with the stored one or more prominent frequencies and the stored one or more prominent amplitudes. The one or more prominent frequencies and the one or more prominent amplitudes corresponding to the extracted first set of audio fingerprints. In an embodiment of the present disclosure, the administrator 110 manually checks whether each supervised advertisement detected is an advertisement or a program.

In an embodiment of the present disclosure, the second processing unit 108 extracts the first set of audio fingerprints and the first set of video fingerprints corresponding to another channel. The second processing unit 108 extracts the pre-defined number of prominent frames and generates pre-defined number of digital signature values. The second processing unit 108 performs probabilistic matching of digital signature values corresponding to the video with the stored digital signature values in the master database 112 to detect a repeated advertisement. In an embodiment of the present disclosure, the second processing unit 108 generates the one or more prominent frequencies of the audio. In another embodiment of the present disclosure, the second processing unit 108 discards the audio from the media content. In an embodiment of the present disclosure, the master database 112 includes the one or more advertisements corresponding to a same advertisement in every regional language. In another embodiment of the present disclosure, the master database 112 includes the advertisement in a specific national language. In embodiment of the present disclosure, the second processing unit probabilistically matches the one or more prominent frequencies with stored prominent frequencies. The stored prominent frequencies correspond to a regional channel having audio in the pre-defined regional language or standard language in the master database 112. In an embodiment of the present disclosure, the standard language is English. In another embodiment of the present disclosure, the second processing unit 108 gives precedence to results of probabilistic match of video fingerprints than to the audio fingerprints.

In an embodiment of the present disclosure, the advertisement detection system 104 reports a frequency of each advertisement broadcasted for a first time and a frequency of each advertisement broadcasted repetitively. In another embodiment of the present disclosure, the administrator 110 reports the frequency of each advertisement broadcasted for the first time and the frequency of each advertisement broadcasted repetitively.

Further, the master database 112 is present in a master server. The master database 112 includes a plurality of digital video and audio fingerprint records and every signature value corresponding to each previously detected and newly detected advertisement. The master database 112 is connected to the advertisement detection system 104. In an embodiment of the present disclosure, the master server is present in a remote location. In another embodiment of the present disclosure, the master server is present locally with the advertisement detection system 104.

Further, the advertisement detection system 104 stores the generated set of digital signature values, the first set of audio fingerprints and the first set of video fingerprints in the first database 106a and the second database 108a. Furthermore, the advertisement detection system 104 updates the first metadata manually in the master database 112 for the unsupervised detection of the one or more advertisements. The first metadata includes the set of digital signature values and the first set of video fingerprints.

It may be noted that in FIG. 1A, FIG. 1B and FIG. 1C, the system 100 includes the broadcast reception device 102 for decoding one channel; however, those skilled in the art would appreciate the system 100 includes more number of broadcast reception devices for decoding more number of channels. It may be noted that in FIG. 1A, FIG. 1B and FIG. 1C, the system 100 includes the advertisement detection system 104 for the supervised and the unsupervised detection of the one or more advertisement corresponding to one channel; however, those skilled in the art would appreciate that the advertisement detection system 104 detects the one or more advertisements corresponding to more number of channels. It may be noted that in FIG. 1A, FIG. 1B and FIG. 1C, the administrator 110 manually checks each newly detected advertisement in the master database 112; however, those skilled in the art would appreciate that the advertisement detection system 104 automatically checks for each advertisement in the master database 112.

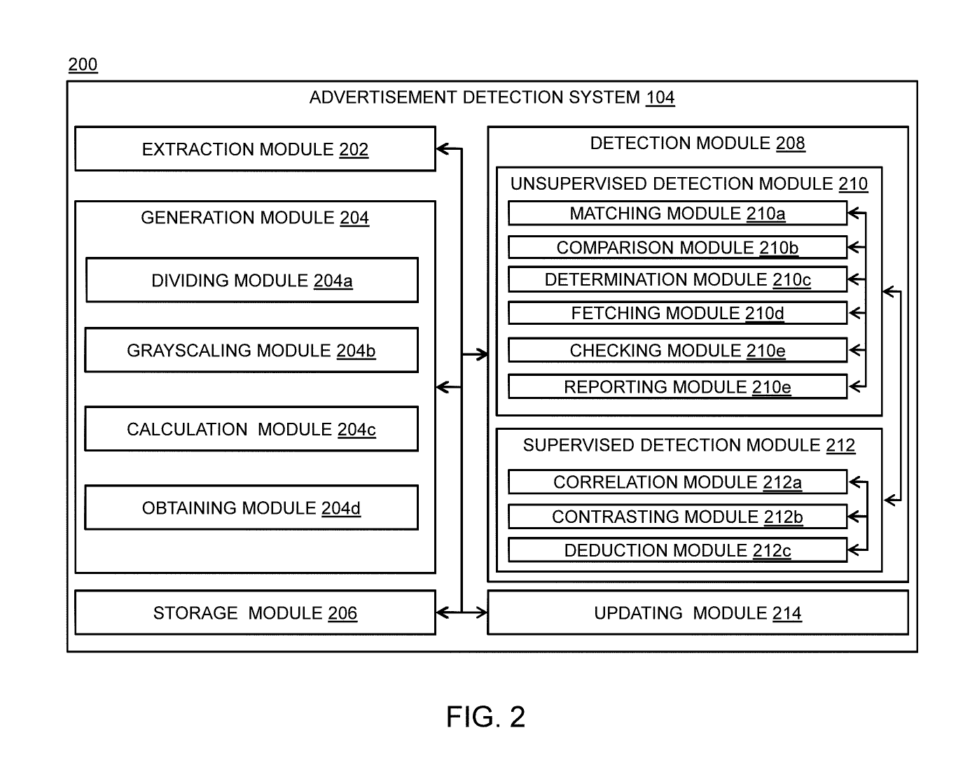

FIG. 2 illustrates a block diagram 200 of the advertisement detection system 104, in accordance with various embodiments of the present disclosure. The block diagram 200 describes the advertisement detection system 104 configured for the unsupervised and the supervised detection of the one or more advertisements.

The block diagram 200 of the advertisement detection system 104 includes an extraction module 202, a generation module 204, a storage module 206, a detection module 208 and an updating module 214. The extraction module 202 extracts the first set of audio fingerprints and the first set of video fingerprints corresponding to the media content broadcasted on the channel. The first set of audio fingerprints and the first set of video fingerprints are extracted sequentially in the real time (as shown in detailed description of FIG. 1A).

Further, the generation module 204 generates the set of digital signature values corresponding to the extracted set of video fingerprints. The generation module 204 generates each digital signature value of the set of digital signature values by dividing and grayscaling each prominent frame into the pre-defined number of blocks. Further, the generation module 204 calculates and obtains each digital signature value corresponding to each block of the prominent frame (as shown in detailed description of FIG. 1A). The generation module 204 includes a dividing module 204a, a grayscaling module 204b, a calculation module 204c and an obtaining module 204d. The dividing module 204a divides each prominent frame of the one or more prominent frames into the pre-defined number of blocks (as shown in detailed description of FIG. 1A). The grayscaling module 204b grayscales each block of each prominent frame of the one or more prominent frames. The calculation module 204c calculates the first bit value and the second bit value for each block of the prominent frame (as described in the detailed description of FIG. 1A). The obtaining module 204d obtains the 32 bit digital signature value corresponding to each prominent frame (as described in detailed description of FIG. 1A).

The storage module 206 stores the generated set of digital signature values, the first set of audio fingerprints and the first set of video fingerprints in the first database 106a and the second database 108a (as described in detailed description of FIG. 1A). Further, the detection module 208 detects the one or more advertisements broadcasted on the channel. The detection module 208 includes an unsupervised detection module 210 and the supervised detection module 212. The unsupervised detection module 210 detects a new advertisement through unsupervised machine learning. The unsupervised detection module 210 includes a matching module 210a, a comparison module 210b, a determination module 210c, a fetching module 210d, a checking module 210e and a reporting module 210f. The matching module 210a probabilistically matches the first pre-defined number of digital signature values corresponding to the pre-defined number of prominent frames with the stored set of digital signature values (as described in detailed description of FIG. 1A).

Furthermore, the comparison module 210b compares the one or more prominent frequencies and the one or more prominent amplitudes of the extracted first set of audio fingerprints (as described in detailed description of FIG. 1A). The determination module 210c determines the positive probabilistic match of the pre-defined number of prominent frames based on the pre-defined condition (as described in the detailed description of FIG. 1A). The fetching module 210d fetches the video and the audio clip corresponding to the probabilistically matched digital signature values (as described in the detailed description of FIG. 1A). Moreover, the checking module 210e checks presence of the audio and the video clip manually in the master database 112 (as described in detailed description of FIG. 1A). In addition, the reporting module 210f reports the positively matched digital signature values corresponding to the advertisement of the one or more advertisements in the reporting database present in the first database 106a (as described in the detailed description of FIG. 1A).

The supervised detection module 212 includes a correlation module 212a, contrasting module 212b and a deduction module 212c. The correlation module 212a probabilistically matches the second pre-defined number of digital signature values with the stored set of digital signature values present in the master database 112 (as described above in the detailed description of FIG. 1A). Further, the contrasting module 212b comparing the one or more prominent frequencies and the one or more prominent amplitudes with the stored one or more prominent frequencies and the stored one or more prominent amplitudes (as described in the detailed description of FIG. 1A). The deduction module 212c determines the positive match in the probabilistically matching of the second pre-defined number of digital signature values with the stored set of digital signature values in the master database 112. In addition, the deduction module 212d determines the positive match from the comparison of the one or more prominent frequencies with the stored one or more prominent frequencies (as described in the detailed description of FIG. 1A).

Going further, the updating module 214 updates the first metadata manually in the master database 112 for the unsupervised detection of the one or more advertisements. The first metadata includes the set of digital signature values and the first set of video fingerprints corresponding to the detected advertisement (as described in the detailed description of FIG. 1A).

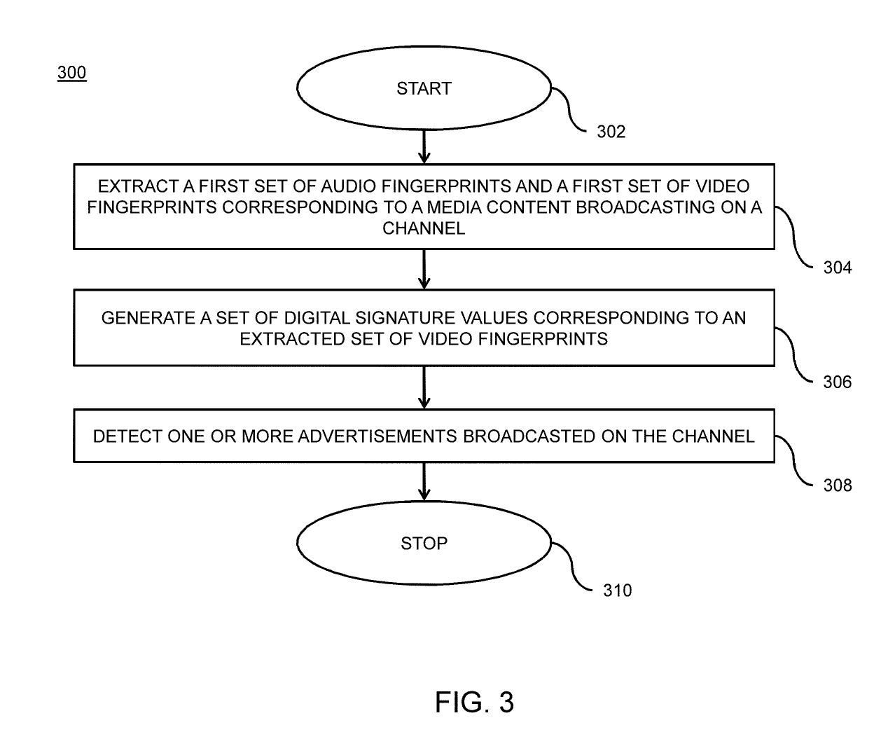

FIG. 3 illustrates a flow chart 300 for the unsupervised and the supervised detection of the one or more advertisements broadcasted on the channel, in accordance with various embodiments of the present disclosure. It may be noted that to explain the process steps of the flowchart 300, references will be made to the interactive messaging system elements of the FIG. 1A, FIG. 1B, FIG. 1C and FIG. 2.

The flowchart 300 initiates at step 302. At step 304, the extraction module 202 extracts the first set of audio fingerprints and the first set of video fingerprints corresponding to the media content broadcasted on the channel. The first set of audio fingerprints and the first set of video fingerprints is extracted sequentially in the real time. At step 306, the generation module 204 generates the set of digital signature values corresponding to the extracted set of video fingerprints. Further, at step 308, the detection module 208 detects the one or more advertisements broadcasted on the channel. The flow chart 300 terminates at step 312.

It may be noted that the flowchart 300 is explained to have above stated process steps; however, those skilled in the art would appreciate that the flowchart 300 may have more/less number of process steps which may enable all the above stated embodiments of the present disclosure.

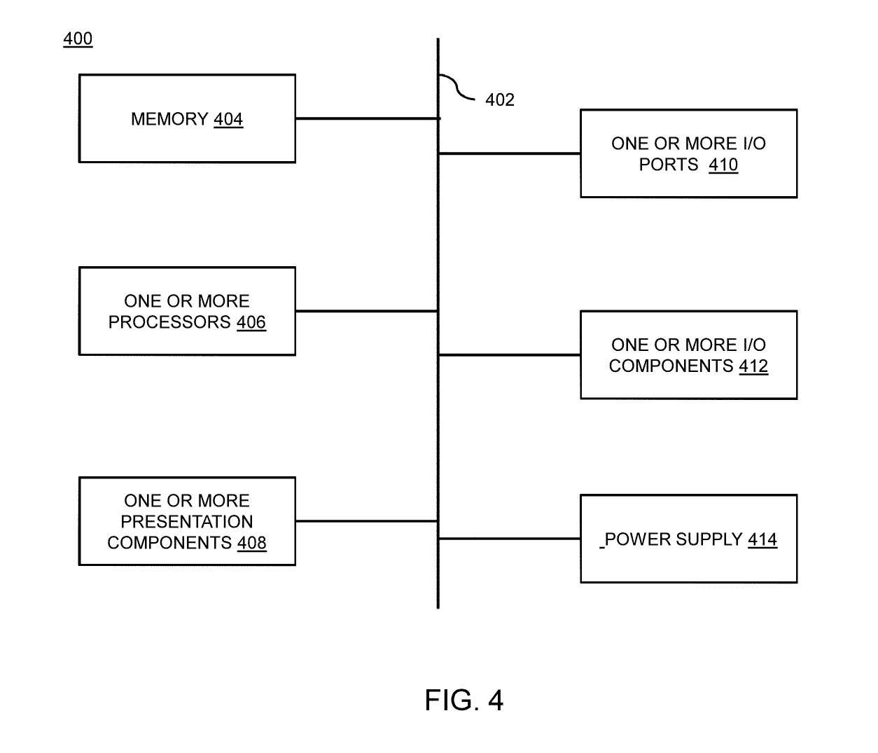

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more buses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The present disclosure has numerous disadvantages over the prior art. The present disclosure provides a novel method to detect any new advertisement running for the first time on any television channel. The advertisements are detected robustly and dedicated supervised and unsupervised central processing unit (hereinafter “CPU”) are installed. Further, the present disclosure provides a method and system that is economic and provides high return of investment. The detection of each repeated advertisement on supervised CPU and each new advertisement on unsupervised CPU significantly saves processing power and saves significant time. The disclosure provides a cost efficient solution to a scaled mapping and database for advertisement broadcast.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for detecting one or more advertisements broadcasted on a channel in real time, the computer-implemented method comprising:
extracting, at an advertisement detection system with a processor, a first set of audio fingerprints and a first set of video fingerprints corresponding to a media content broadcasting on the channel, wherein the first set of audio fingerprints and the first set of video fingerprints being extracted sequentially in real time and wherein the first set of video fingerprints being extracted by sequentially extracting one or more prominent fingerprints corresponding to one or more prominent frames of a pre-defined number of frames present in the media content for a pre-defined interval of broadcast;
generating, at the advertisement detection system with the processor, a set of digital signature values corresponding to the first set of video fingerprints, the set of digital signature values being generated by:
dividing each prominent frame of the one or more prominent frames into a pre-defined number of blocks, wherein each block of the pre-defined number of blocks having a pre-defined number of pixels;
grayscaling each block of each prominent frame of the one or more prominent frames;
calculating a first bit value and a second bit value for each block of the prominent frame, wherein the first bit value and the second bit value being calculated from comparing a mean and a variance for the pre-defined number of pixels in each block of the prominent frame with a corresponding mean and variance for a master frame in a master database;
obtaining a 32 bit digital signature value corresponding to each prominent frame, wherein the 32 bit digital signature value being obtained by sequentially arranging the first bit value and the second bit value for each block of the pre-defined number of blocks of the prominent frame; and
detecting, at the advertisement detection system with the processor, the one or more advertisements broadcasted on the channel, wherein the one or more advertisements being detected based on at least one of a supervised detection and an unsupervised detection.

2. The computer-implemented method as recited in claim 1, further comprising storing, at the advertisement detection system with the processor, the generated set of digital signature values, the first set of audio fingerprints and the first set of video fingerprints in a first database and a second database.

3. The computer-implemented method as recited in claim 1, wherein the first bit value and the second bit value being assigned a binary 0 when the mean and the variance for each block of the prominent frame being less than the corresponding mean and variance of each master frame.

4. The computer-implemented method as recited in claim 1, wherein the first bit value and the second bit value being assigned a binary 1 when the mean and the variance for each block of the prominent frame being greater than the corresponding mean and variance of each master frame.

5. The computer-implemented method as recited in claim 1, wherein the unsupervised detection of the one or more advertisements being done by:
probabilistically matching a first pre-defined number of digital signature values corresponding to a pre-defined number of prominent frames of a real time broadcasted media content with a stored set of digital signature values present in a first database, wherein the probabilistic match being performed for the set of digital signature values by utilizing a sliding window algorithm;
comparing one or more prominent frequencies and one or more prominent amplitudes of the extracted first set of audio fingerprints;
determining a positive probabilistic match of the pre-defined number of prominent frames based on a pre-defined condition;
fetching a video and an audio clip corresponding to the probabilistically matched digital signature values;
checking presence of the audio and the video clip manually in a master database; and
reporting a positively matched digital signature values corresponding to an advertisement of the one or more advertisements in a reporting database present in the first database.

6. The computer-implemented method as recited in claim 5, wherein the pre-defined condition comprises a pre-defined range of positive matches corresponding to probabilistically matched digital signature values, a pre-defined duration of media content corresponding to the positive match, a sequence and an order of the positive matches and a degree of match of a pre-defined range of number of bits of the first pre-defined number of digital signature values.

7. The computer-implemented method as recited in claim 5, wherein the first pre-defined number of digital signature values of the set of digital signature values for the unsupervised detection of the one or more advertisements being 20.

8. The computer-implemented method as recited in claim 1, further comprising, updating, at the advertisement detection system with the processor, a first metadata comprising the set of digital signature values and the first set of video fingerprints corresponding to a detected advertisement manually in a master database for an unsupervised detection.

9. The computer-implemented method as recited in claim 1, wherein the supervised detection of the one or more advertisements being done by:
probabilistically matching a second pre-defined number of digital signature values corresponding to a pre-defined number of prominent frames of a real time broadcasted media content with a stored set of digital signature values present in a master database, wherein the probabilistic match being performed for the set of digital signature values by utilizing a sliding window algorithm;
comparing one or more prominent frequencies and one or more prominent amplitudes corresponding to the extracted first set of audio fingerprints with a stored one or more prominent frequencies and a stored one or more prominent amplitudes; and
determining a positive match in the probabilistically matching of the second pre-defined number of digital signature values with the stored set of digital signature values in the master database and comparing of the one or more prominent frequencies and the one or more prominent amplitudes corresponding to the extracted first set of audio fingerprints with the stored one or more prominent frequencies and the stored one or more prominent amplitudes.

10. The computer-implemented method as recited in claim 9, wherein the second pre-defined number of digital signature values of the set of digital signature values for the supervised detection of the one or more advertisements being 6.

11. A computer system comprising:
one or more processors; and
a memory coupled to the one or more processors, the memory for storing instructions which, when executed by the one or more processors, cause the one or more processors to perform a method for detecting one or more advertisements broadcasted on a channel in real time, the method comprising:
extracting, at an advertisement detection system, a first set of audio fingerprints and a first set of video fingerprints corresponding to a media content broadcasting on the channel, wherein the first set of audio fingerprints and the first set of video fingerprints being extracted sequentially in real time and wherein the first set of video fingerprints being extracted by sequentially extracting one or more prominent fingerprints corresponding to one or more prominent frames of a pre-defined number of frames present in the media content for a pre-defined interval of broadcast;
generating, at the advertisement detection system, a set of digital signature values corresponding to the first set of video fingerprints, the set of digital signature values being generated by:
dividing each prominent frame of the one or more prominent frames into a pre-defined number of blocks, wherein each block of the pre-defined number of block having a pre-defined number of pixels;
grayscaling each block of each prominent frame of the one or more prominent frames;
calculating a first bit value and a second bit value for each block of the prominent frame, wherein the first bit value and the second bit value being calculated from comparing a mean and a variance for the pre-defined number of pixels in each block of the prominent frame with a corresponding mean and variance for a master frame in a master database;
obtaining a 32 bit digital signature value corresponding to each prominent frame, wherein the 32 bit digital signature value being obtained by sequentially arranging the first bit value and the second bit value for each block of the pre-defined number of blocks of the prominent frame; and
detecting, at the advertisement detection system, the one or more advertisements broadcasted on the channel, wherein the one or more advertisements being detected based on at least one of a supervised detection and an unsupervised detection.

12. The computer system as recited in claim 11, further comprising storing, at the advertisement detection system, the set of digital signature values, the first set of audio fingerprints and the first set of video fingerprints in a first database and a second database.

13. The computer system as recited in claim 11, wherein the unsupervised detection of the one or more advertisements being done by:
probabilistically matching a first pre-defined number of digital signature values corresponding to a pre-defined number of prominent frames of a real time broadcasted media content with a stored set of digital signature values present in a first database, wherein the probabilistic match being performed for the set of digital signature values by utilizing a sliding window algorithm;
comparing one or more prominent frequencies and one or more prominent amplitudes of the extracted first set of audio fingerprints;
determining a positive probabilistic match of the pre-defined number of prominent frames based on a pre-defined condition;
fetching a video and an audio clip corresponding to the probabilistically matched digital signature values;
checking presence of the audio and the video clip manually in a master database; and
reporting a positively matched digital signature values corresponding to an advertisement of the one or more advertisements in a reporting database present in the first database.

14. The computer system as recited in claim 13, wherein the pre-defined condition comprises a pre-defined range of positive matches corresponding to the probabilistically matched digital signature values, a pre-defined duration of media content corresponding to the positive match, a sequence and an order of the positive matches and a degree of match of a pre-defined range of number of bits of the first pre-defined number of signature values.

15. The computer system as recited in claim 13, wherein the first pre-defined number of digital signature values of the set of digital signature values for the unsupervised detection of the one or more advertisements being 20.

16. The computer system as recited in claim 11, wherein the supervised detection of the one or more advertisements being done by:
probabilistically matching a second pre-defined number of digital signature values corresponding to a pre-defined number of prominent frames of a real time broadcasted media content with a stored set of digital signature values present in a master database, wherein the probabilistic match being performed for the set of digital signature values by utilizing a sliding window algorithm;
comparing one or more prominent frequencies and one or more prominent amplitudes corresponding to the extracted first set of audio fingerprints with a stored one or more prominent frequencies and a stored one or more prominent amplitudes; and
determining a positive match in the probabilistically matching of the second pre-defined number of digital signature values with the stored set of digital signature values in the master database and comparing of the one or more prominent frequencies and the one or more prominent amplitudes corresponding to the extracted first set of audio fingerprints with the stored one or more prominent frequencies and the stored one or more prominent amplitudes.

17. The computer system as recited in claim 16, wherein the second pre-defined number of digital signature values of the set of digital signature values for the supervised detection of the one or more advertisements being 6.

18. A computer-readable storage medium encoding computer executable instructions that, when executed by at least one processor, performs a method for detecting one or more advertisements broadcasted on a channel in real time, the method comprising:
extracting, at a computing device, a first set of audio fingerprints and a first set of video fingerprints corresponding to a media content broadcasting on the channel, wherein the first set of audio fingerprints and the first set of video fingerprints being extracted sequentially in real time and wherein the first set of video fingerprints being extracted by sequentially extracting one or more prominent fingerprints corresponding to one or more prominent frames of a pre-defined number of frames present in the media content for a pre-defined interval of broadcast;
generating, at the computing device, a set of digital signature values corresponding to the extracted first set of video fingerprints, the set of digital signature values being done by:
dividing each prominent frame of the one or more prominent frames into a pre-defined number of blocks, wherein each block of the pre-defined number of block having a pre-defined number of pixels;
grayscaling each block of each prominent frame of the one or more prominent frames;
calculating a first bit value and a second bit value for each block of the prominent frame, wherein the first bit value and the second bit value being calculated from comparing a mean and a variance for the pre-defined number of pixels in each block of the prominent frame with a corresponding mean and variance for a master frame in a master database;
obtaining a 32 bit digital signature value corresponding to each prominent frame, wherein the 32 bit digital signature value being obtained by sequentially arranging the first bit value and the second bit value for each block of the pre-defined number of blocks of the prominent frame; and
detecting, at the computing device, the one or more advertisements broadcasted on the channel, wherein the one or more advertisements being detected based on at least one of a supervised detection and an unsupervised detection.

19. The computer-readable storage medium as recited in claim 18, wherein the unsupervised detection of the one or more advertisements being done by:
probabilistically matching a first pre-defined number of digital signature values corresponding to a pre-defined number of prominent frames of a real time broadcasted media content with a stored set of digital signature values present in a first database, wherein the probabilistic matching being performed for the set of digital signature values by utilizing a sliding window algorithm;
comparing one or more prominent frequencies and one or more prominent amplitudes of the extracted first set of audio fingerprints;
determining a positive probabilistic match of the pre-defined number of prominent frames based on a pre-defined condition;
fetching a video and an audio clip corresponding to a probabilistically matched digital signature values;
checking presence of the audio and the video clip manually in a master database; and
reporting a positively matched digital signature values corresponding to an advertisement of the one or more advertisements in a reporting database present in the first database.

20. The computer-readable storage medium as recited in claim 18, wherein the supervised detection of the one or more advertisements being done by:
probabilistically matching a second pre-defined number of digital signature values corresponding to a pre-defined number of prominent frames of a real time broadcasted media content with a stored set of digital signature values present in a master database, wherein the probabilistic match being performed for the set of digital signature values by utilizing a sliding window algorithm;
comparing one or more prominent frequencies and one or more prominent amplitudes corresponding to the extracted first set of audio fingerprints with a stored one or more prominent frequencies and a stored one or more prominent amplitudes in the master database; and
determining a positive match in a probabilistic matching of the second pre-defined number of digital signature values with the stored set of digital signature values in the master database and comparing of the one or more prominent frequencies and the one or more prominent amplitudes corresponding to the extracted first set of audio fingerprints with the stored one or more prominent frequencies and the stored one or more prominent amplitudes.
